(19) United States
(12) Patent Application Publication
(10) Pub. No.: US 2008/0295700 A1
(43) Pub. Date: Dec. 4, 2008

(54) Coffee Percolator

(75) Inventor: Virginio Cortese, Torino (IT)

Correspondence Address: Luce, Forward, Hamilton & Scripps, 11988 El Camino Real, Suite 200, San Diego, CA, 92130, US

(73) Assignee: SGL ITALIA S.R.L., Torino (IT)

(21) Appl. No.: 11/631,278

(22) PCT Filed: Jun. 23, 2005
(86) PCT No.: PCT/EP2005/052953

§ 371 Date: Jan. 8, 2008

(30) Foreign Application Priority Data
Jun. 29, 2004 (IT) TO2004A000443

(51) Int. Cl. A47J 31/44; A47J 31/06

(52) U.S. Cl. 99/319; 99/292

(57) ABSTRACT

A coffee percolator having a vertical axis, and wherein a pressurized-hot-water dispensing assembly has a bottom outlet facing a top surface of a fixed annular body supporting a percolating cup, which engages the annular body removably and is connected to the annular body by a bayonet joint defined partly by at least one sloping surface formed on the top surface of the annular body.

### TECHNICAL FIELD

The present invention relates to a coffee percolator.

More specifically, the present invention relates to a coffee percolator of the type having a vertical axis, and comprising a pressurized-hot-water dispensing assembly having an outlet coaxial with said axis; a fixed annular body coaxial with said axis and positioned with a top surface facing said outlet; a percolating cup which engages the annular body; and a bayonet joint for connecting the percolating cup to the annular body coaxially with said axis and facing said outlet.

### BACKGROUND ART

In coffee percolators of the type described above, the bayonet joint normally comprises two helical grooves formed on an outer wall of the percolating cup, and which are engaged by respective pins projecting radially from an inner lateral surface of the annular body. The helical grooves are normally closed at the top ends so that the pins, once engaged inside the respective grooves when assembling the percolator, connect the percolating cup permanently to the annular body, and slide, in use, along the grooves to allow the percolating cup to move, with respect to the annular body and in a substantially vertical direction, to and from an operating position connected to the pressurized-hot-water outlet.

In known percolators of the type described above, the vertical movement and—since the percolating cup cannot be removed from the annular body—the gap formed between the outlet and the percolating cup, when the percolating cup is withdrawn from the operating position, are necessarily small, so that the percolating cup can only be loaded with a fairly thin wafer, and definitely not loose ground coffee or a relatively thick rigid capsule.

### DISCLOSURE OF INVENTION a

It is an object of the present invention to provide a percolator of the type described above, designed to produce coffee from a wafer, from a rigid capsule, and from a measure of loose ground coffee, and which at the same time is cheap and easy to produce.

According to the present invention, there is provided a coffee percolator, as claimed in Claim 1 and, preferably, in any one of the following Claims depending directly or indirectly on Claim 1.

### BRIEF DESCRIPTION OF THE DRAWINGS

A non-limiting embodiment of the invention will be described by way of example with reference to the accompanying drawings, in which:

FIG. 1 shows a partly sectioned side view of a preferred embodiment of the percolator according to the present invention;

FIG. 2 shows a section along line II-II in FIG. 1;

FIG. 3 is similar to FIG. 1 and shows the percolator in a different operating configuration;

FIG. 4 shows a section along line IV-IV in FIG. 3.

### BEST MODE FOR CARRYING OUT THE INVENTION

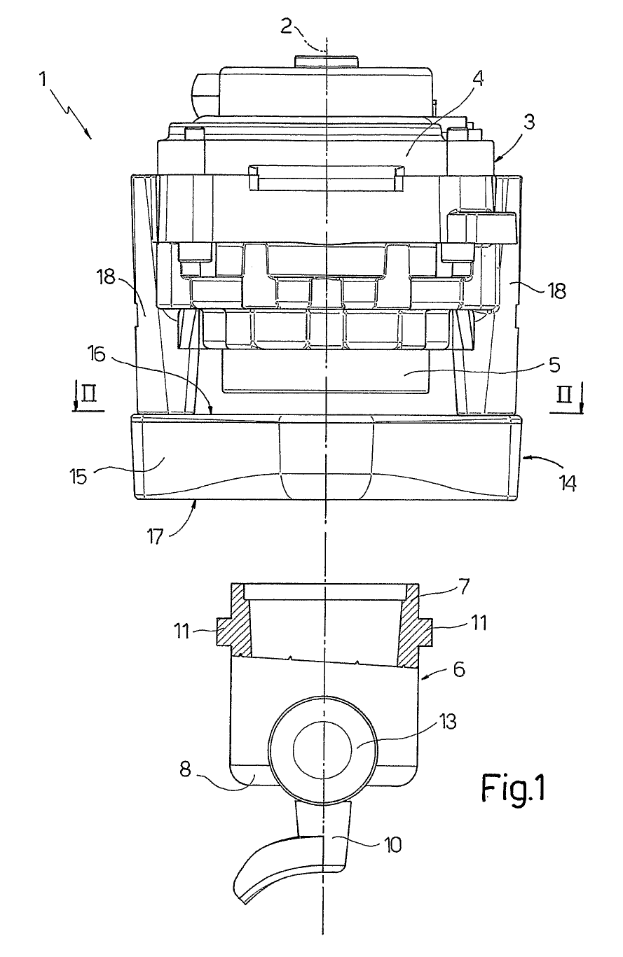

Number 1 in FIG. 1 indicates as a whole a coffee percolator, which extends along a vertical axis 2, and comprises a pressurized-hot-water dispensing assembly 3 in turn comprising a boiler 4, and a sprinkler 5 fitted to boiler 4, coaxially with axis 2, and defining an outlet of dispensing assembly 3.

Percolator 1 also comprises a percolating cup 6 defined by a cup-shaped body comprising a cylindrical lateral wall 7 closed at one end by a bottom wall 8, through which is formed a discharge conduit 9 communicating with a coffee dispensing device 10. Cylindrical lateral wall 7 has two diametrically-opposite, outer radial appendixes 11 located close to a free edge of percolating cup 6 and forming part of a bayonet joint 12 which, as explained in detail below, locks percolating cup 6 axially and angularly in an operating position, in which percolating cup 6 faces dispensing assembly 3, with the free edge of the percolating cup contacting sprinkler 5.

Percolating cup 6 is fitted with a handle 13 extending radially outwards from lateral wall 7.

As regards percolating cup 6, it should be pointed out that, in the example shown, lateral wall 7 is high enough for percolating cup 6 to house a rigid container of ground coffee.

In other embodiments not shown, percolating cup 6 is loaded with a known wafer (not shown) of ground coffee, or with a measure of loose ground coffee. Since, in both these cases, percolating cup 6 would be deeper than necessary, percolator 1 is equipped with a known auxiliary filtering element (not shown), which is insertable at least partly inside percolating cup 6, 9 coaxially with axis 2, to reduce the depth of percolating cup 6.

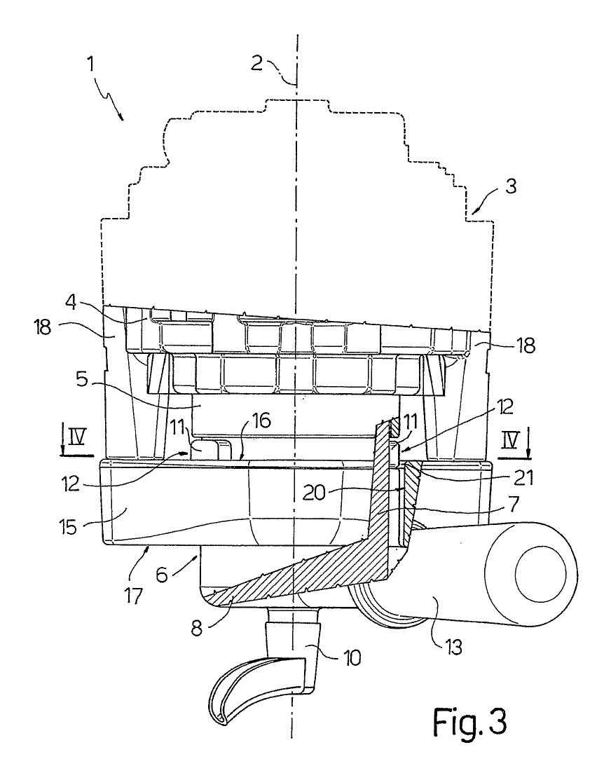

With reference to FIGS. 1 and 3, percolator 1 comprises a device 14 for supporting and locking percolating cup 6 in said operating position, and in turn comprising an annular body 15, which is positioned facing sprinkler 5, coaxially with axis 2, is bounded at the top and bottom respectively by two flat surfaces 16 and 17 crosswise to axis 2, and is fitted to dispensing assembly 3 by two columns 18 extending upwards from surface 16 and connected rigidly at their top ends to a supporting ring integral with boiler 4.

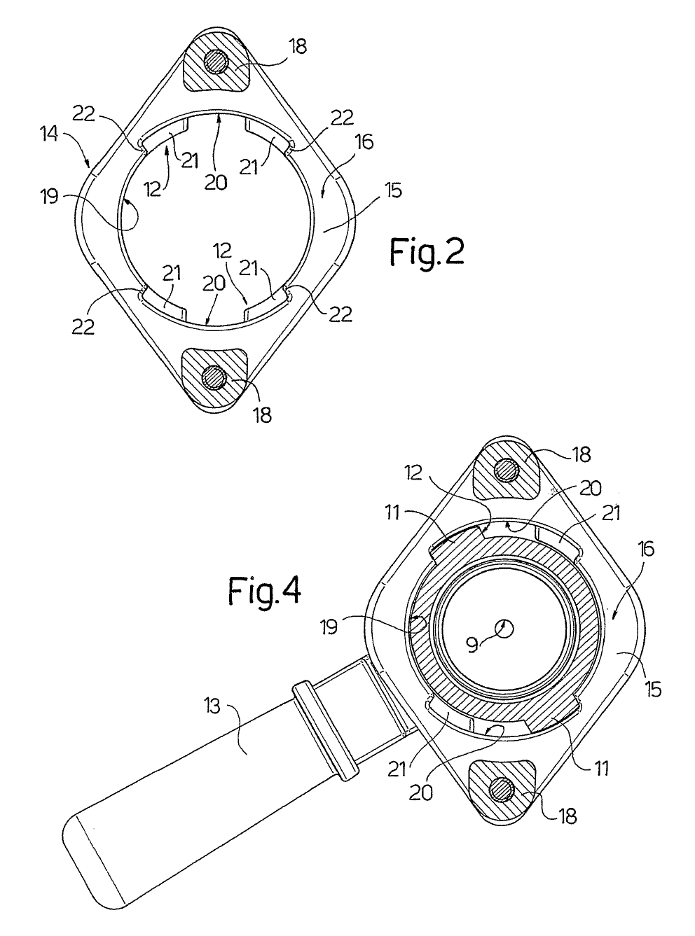

As shown in FIGS. 2 and 4, annular body 15 is bounded internally by a cylindrical surface 19, coaxial with axis 2 and of a diameter approximately equal to but no smaller than the outside diameter of percolating cup 6, and comprises two diametrically-opposite, axial grooves 20, each of which extends from surface 16 to surface 17, and is engaged in transversely sliding manner by a respective appendix 11 of percolating cup 6.

Finally, two sloping surfaces 21 are formed on surface 16, along the inner periphery of annular body 15, and at the top end of each groove 20, are symmetrical with respect to respective groove 20, and slope upwards from groove 20 towards sprinkler 5 at the same angle but in opposite directions. Each sloping surface 21 adjacent to one groove 20 is therefore diametrically opposite a corresponding sloping surface 21 adjacent to the other groove 20, and the two form a respective pair of sloping surfaces 21, which, together with appendixes 11, defines bayonet joint 12. Each sloping surface 21 in each pair is engaged, in use, by a respective appendix 11, and is bounded, at the opposite end to the one communicating with relative groove 20, by a respective radial shoulder 22 defining a stop for arresting relative appendix 11 along sloping surface 21.

In actual use, to insert percolating cup 6 inside annular body 15, the user positions percolating cup 6—fully detached from annular body 15 (FIG. 1)—beneath annular body 15, coaxially with axis 2, and with the two appendixes 11 aligned with grooves 20. When percolating cup 6 is moved vertically upwards by the user, each appendix 11 engages and slides along respective groove 20 to a level above the top end of groove 20.

At this point, when handle 13 is rotated clockwise or anticlockwise, one of the two pairs of opposite sloping surfaces 21 is engaged by appendixes 11, each of which slides along respective sloping surface 21 until it is arrested against respective shoulder 22, thus locking percolating cup 6 in the operating position.

In connection with the above, it should be pointed out that providing two pairs of sloping surfaces 21 allows handle 13 to be rotated by the user either clockwise or anticlockwise, depending on the space available and/or user preference.

In a variation not shown, the top end of each groove 20 communicates with the bottom end of only one sloping surface 21.

In a further variation not shown, percolating cup 6 has only one appendix 11, which cooperates with a respective groove 20 communicating with the bottom end of one or two sloping surfaces 21.

1. A coffee percolator having a vertical axis and comprising a pressurized-hot-water dispensing assembly having an outlet coaxial with said axis; a fixed annular body coaxial with said axis and positioned with a top surface facing said outlet and a bottom surface facing away from said outlet; a percolating cup, which engages the annular body; and a bayonet joint for connecting the percolating cup to the annular body coaxially with said axis and facing said outlet; the percolator being characterized in that the percolating cup is so mounted as to be extractable axially through the annular body and the bottom surface; and said bayonet joint comprises at least one sloping surface formed on said top surface

2. A percolator as claimed in claim 1, wherein said bayonet joint comprises, for each said sloping surface, an appendix extending radially outwards from said percolating cup, and an axial groove formed on an inner surface of said annular body and engaged in sliding manner by said appendix; said axial groove being a through axial groove extending between said top and bottom surfaces to permit detachment of the percolating cup from the annular body.

3. A percolator as claimed in claim 2, wherein said axial groove extends through said top surface and is adjacent to a bottom end of said sloping surface.

4. A percolator as claimed in claim 1, wherein said bayonet joint comprises at least two said sloping surfaces formed on said top surface and diametrically opposite each other; and, for each said sloping surface, a through axial groove formed on an inner surface of said annular body, extending through said top surface, and adjacent to a bottom end of the relative sloping surface, and an appendix projecting radially outwards from the percolating cup and which engages said axial groove in sliding manner.

5. A percolator as claimed in claim 2, wherein said bayonet joint comprises, for each said axial groove, two oppositely inclined said sloping surfaces located on opposite sides of a top end of the relative axial groove; said two sloping surfaces being engaged selectively by the relative said appendix.

6. A percolator as claimed in claim 1, wherein said sloping surface is bounded at the top by a radial stop shoulder.
